(19) United States
(12) Patent Application Publication
(10) Pub. No.: US 2021/0337452 A1
(43) Pub. Date: Oct. 28, 2021

(54) SHARING GEOGRAPHICALLY CONCENTRATED WORKLOAD AMONG NEIGHBORING MEC HOSTS OF MULTIPLE CARRIERS

(71) Applicant: International Business Machines Corporation, Armonk, NY (US)

(72) Inventors: Sanehiro FURUICHI, Setagaya-ku (JP); Kenichi TAKASAKI, Shibuya (JP); Shoichiro WATANABE, Nerima-ku (JP); Yasutaka NISHIMURA, Yamato-shi (JP)

(21) Appl. No.: 16/857,158

(22) Filed: Apr. 23, 2020

(51) Int. Cl. H04W 36/30

(52) U.S. Cl. CPC H04W 36/30

(57) ABSTRACT

In aggregating application functions on multi-access edge computing (MEC) hosts across multiple carriers, a system associated with a particular application receives performance data from a first and second MEC hosts. The first MEC host is deployed on a first network carrier and coupled to first user terminals. The second MEC host is deployed on a second network carrier and coupled to second user terminals. The particular application is installed on the first and second MEC hosts. The system determines whether the performance data from the second MEC host exceeds a threshold value. If so, the system sends instructions to the second MEC host to aggregate function(s) of the particular application to the first MEC host. As a result, each of the first and second user terminals connect to the first MEC host to receive content for the particular application.

### BACKGROUND

The fifth generation wireless communication technologies, commonly known as “5G”, is directed not only to realize a high capacity and high speed communication line, but also to meet various performance needs, such as latency reductions, reliability improvements, and concurrent connections with a large number of user terminals. For certain use cases, multi-access edge computing (MEC) can be deployed at the network edge of the communication network, near the user terminals, to run applications, such as autonomous vehicles, telemedicine, and video distribution. Such use cases can leverage both the features of 5G and MEC.

### SUMMARY

Disclosed herein is a method for aggregating application functions installed on a plurality of MEC hosts of a plurality of carriers in a single MEC host, and a computer program product and system as specified in the independent claims. Embodiments of the present invention can be freely combined with each other if they are not mutually exclusive.

According to an embodiment of the present invention, application functions are aggregated on multi-access edge computing (MEC) hosts across multiple carriers. An application service provider system is associated with a particular application. The application service provider system receives performance data from a first MEC host and a second MEC host. The first MEC host is deployed on a network of a first carrier and coupled to a first plurality of user terminals. The second MEC host is deployed on a network of a second carrier and coupled to a second plurality of user terminals. The particular application is installed on the first MEC host and the second MEC host. The application service provider system determines whether the performance data from the second MEC host exceeds a threshold value. In response to determining that the performance data from the second MEC host exceeds the threshold value, the application service provider system sends instructions to the second MEC host to aggregate one or more functions of the particular application to the first MEC host.

In some embodiments, the application service provider system determines that delivery of content for the particular application is to be aggregated at the first MEC host based at least on load distribution criteria and sends the instructions to an application server in the second MEC host to aggregate the one or more functions of the particular application to an application server in the first MEC host.

In some embodiments, in response to receiving the instructions from the application service provider system, the second MEC host sends second instructions to each of the second plurality of user terminals to change a connection for the particular application to the first MEC host.

In some embodiments, after aggregating the one or more functions of the particular application to the first MEC host, the application service provider system receives further performance data related to delivery of content to the first plurality of user terminals and the second plurality of user terminals from the first MEC host and the second MEC host. The application service provider system determines whether the further performance data from the second MEC host is below the threshold value. In response to determining that the further performance data from the second MEC host is below the threshold value, the application service provider system sends second instructions to the first MEC host to change user terminal connections for the particular application to original connections.

In some embodiments, in response to receiving the second instructions from the application service provider system, the first MEC host sends second instructions to each of the first plurality of user terminals and each of the second plurality of user terminals to change the connection for the particular application to the original connections.

In some embodiments, each of the first and second plurality of user terminals establishes the connection with an original MEC host to receive the content for the particular application.

According to another embodiment of the present invention, in aggregating application functions on multi-access edge computing (MEC) hosts across multiple carriers, an application service provider system receives values for a set of performance criteria from a first MEC host and a second MEC host. The application service provider system is associated with a particular application. The first MEC host is deployed on a network of a first carrier and coupled to a first plurality of user terminals. The second MEC host deployed on a network of a second carrier and coupled to a second plurality of user terminals. The particular application is installed on the first MEC host and the second MEC host. The application provider system determines whether a given combination of the performance criteria in the set from the second MEC host exceeds a threshold value. In response to determining that the given combination of the performance criteria in the set from the second MEC host exceeds the threshold value, the application service provider system determines that delivery of content for the particular application is to be aggregated at the first MEC host based at least on load distribution criteria. The application service provider system sends instructions to an application server in the second MEC host to aggregate the one or more functions of the particular application to an application server in the first MEC host.

In another embodiment of the present invention, one or more functions of a particular application are aggregated to a first MEC host. The first MEC host is deployed on a network of a first carrier and coupled to a first plurality of user terminals subscribed to the first carrier. The first MEC host is further coupled to a second plurality of user terminals subscribed to a second carrier. The second plurality of user terminals is further coupled to a second MEC host deployed on a network of the second carrier. After aggregating the one or more functions of the particular application to the first MEC host, an application service provider system associated with the particular application receives values of a set of performance criteria related to delivery of content to the first plurality of user terminals and the second plurality of user terminals from the first MEC host and the second MEC host. The application service provider system determines whether a given combination of values in the set of performance criteria received from the second MEC host is below the threshold value or whether content delivery for the particular application is finished. In response to determining that the given combination of values in the set of performance criteria from the second MEC host is below the threshold value or determining that the content delivery for the particular application is finished, the application service provider system sends instructions to an application server of the first MEC host to change user terminal connections for the particular application to original connections.

### BRIEF DESCRIPTION OF THE DRAWINGS

FIG. 1 illustrates an overview of a wireless communication network.

FIG. 2 depicts a cloud computing environment according to an embodiment of the present invention.

FIG. 3 depicts abstraction model layers according to an embodiment of the present invention.

FIG. 4 illustrates a Multi-access Edge Computing (MEC) reference architecture. The architecture includes MEC system level management components and MEC host level management components.

FIG. 5 illustrates a distributed deployment of application services on a plurality of MEC hosts for a plurality of carriers.

FIG. 6 illustrates aggregating application functions installed on a plurality of MEC hosts of a plurality of carriers in a single MEC host according to an embodiment of the present invention.

FIG. 7 illustrates a method for aggregating application functions installed on a plurality of MEC hosts of a plurality of carriers in a single MEC host according to an embodiment of the present invention.

FIG. 8 illustrates a method for distributing application functions aggregated on a single MEC host according to an embodiment of the present invention.

FIG. 9 illustrates in more detail the system of aggregating application functions installed on a plurality of MEC hosts of a plurality of carriers in a single MEC host, according to an embodiment of the present invention.

FIG. 10 illustrates in more detail a method for aggregating application functions installed on a plurality of MEC hosts of a plurality of carriers in a single MEC host according to an embodiment of the present invention.

FIG. 11 illustrates in more detail the method for distributing application functions aggregated on a single MEC host according to an embodiment of the present invention.

FIG. 12 illustrates a computer system, one or more of which implements the computing components of the network, according to embodiments of the present invention.

### DETAILED DESCRIPTION

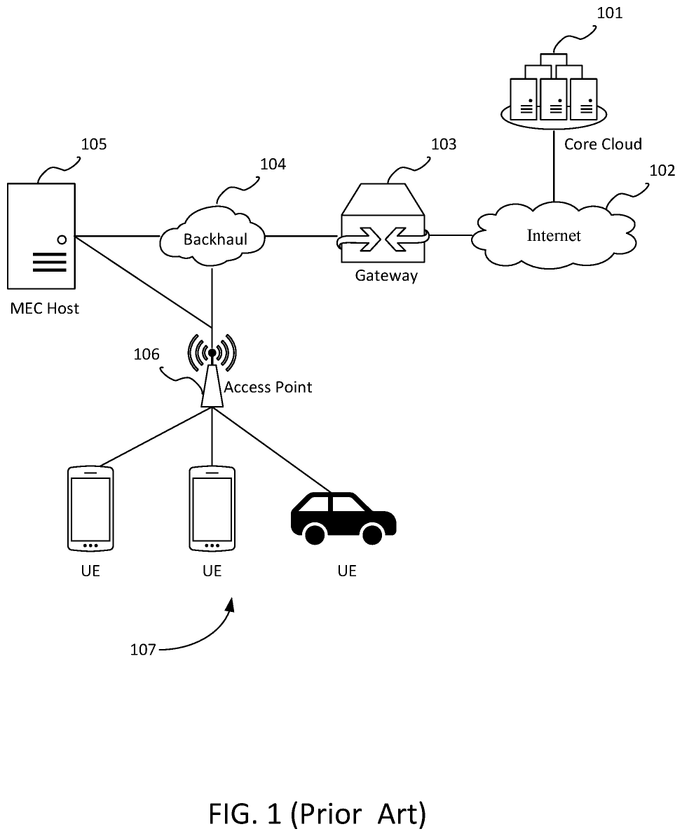

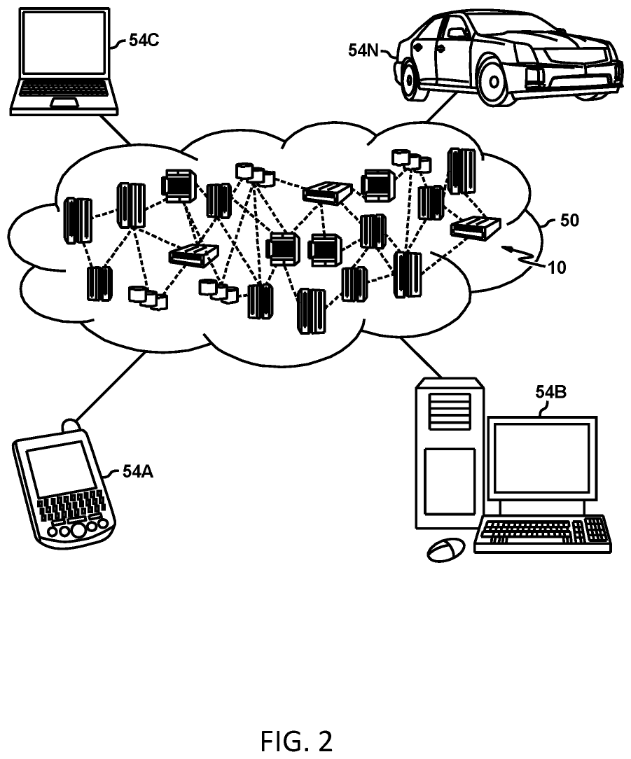

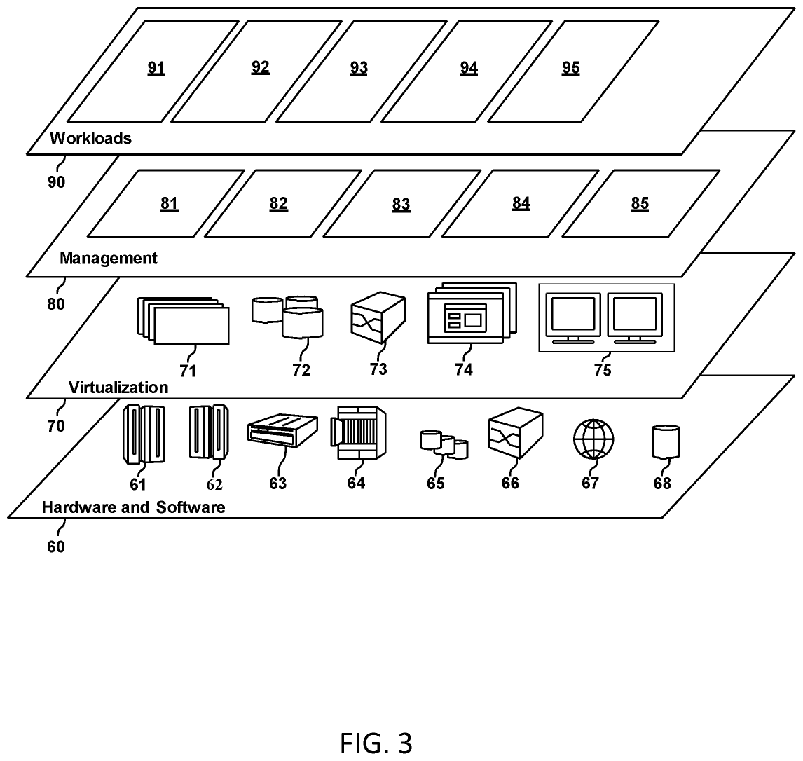

FIG. 1 illustrates an overview of a wireless communication system. The system includes a centralized or core cloud 101 coupled to a gateway 103 over a network, such as the Internet 102. In some embodiments, the core cloud 101 comprises a central cloud computing environment as described further below in reference to FIGS. 2 and 3. The system further includes one or more MEC hosts 105 deployed at a location near user terminals 107, i.e., at the network “edge”, i.e., near a wireless access point 106. The MEC hosts 105 can be coupled to a backhaul 104 comprising intermediate links between the gateway 103 to the core network 101 and the subnetworks comprising the MEC hosts 105 at the edge of the network. Deployment of MEC hosts 105 moves the computing of traffic and services from a centralized or core cloud 101 to the edge of the network and closer to the user terminals 107. Instead of sending all data to the core cloud 101 for processing, the MEC hosts 105 analyze, process, and store the data. Collecting and processing data closer to the user terminals 107 reduces latency.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 3, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

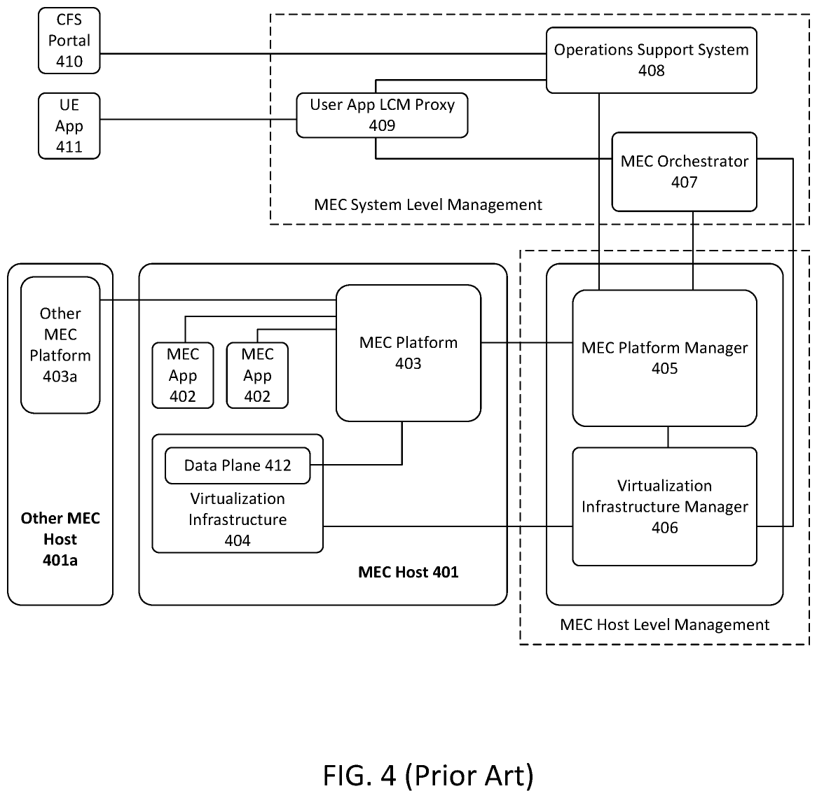

FIG. 4 illustrates a Multi-access Edge Computing (MEC) reference architecture. The architecture includes MEC system level management components and MEC host level management components.

The MEC host 401 is a logical construct which includes the MEC platform 403 and the virtualization infrastructure 404 that provides compute, storage and network resources to the MEC applications 402 installed on the MEC host 401.

The virtualization infrastructure 404 includes a data plane 412 that enforces the forwarding rules received by the MEC platform 403 and routes the traffic between the applications 402, services, and the networks.

The MEC applications 402 run as virtual machines on top of the virtualization infrastructure 404 provided by the MEC host 401 and interact with the MEC platform 403 to handle the MEC services available in the MEC host 401.

The MEC platform 403 includes a collection of baseline functionalities that are required to run applications on the MEC host 401 and enable MEC applications 402 to discover, advertise, provide, and consume the MEC services. Essential functionalities include traffic steering, provision of persistent storage, and time references. The MEC platform 403 further supports configuring the local DNS proxy/server, in order to direct the user traffic to the MEC applications 402.

The MEC platform manager 405 is at the host level and includes components for instantiating, terminating, and relocating a MEC application, as well as providing indications to the MEC orchestrator 407 on application related events. The MEC platform manager 405 further includes components for policy management, including authorizations, traffic rules, DNS configurations, and resolving issues when policies are in conflict.

The virtualization infrastructure manager 406 manages the virtualized resources for the MEC applications 402, such as allocating and releasing virtualized compute, storage, and network resources.

The MEC orchestrator 407 has the visibility over the resources and capabilities of the entire MEC system. The MEC orchestrator 407 is responsible for coordination and control of instantiation, healing, and resolving resources conflicts. The MEC orchestrator 407 is further responsible for managing the MEC applications 402 and related procedures by supporting on-boarding of the applications 402, checking their integrity and authenticity, validating the policies associated with them, and maintaining a catalog of the available applications 402. The MEC orchestrator 407 ensures that application requirements (e.g. latency, user through put, etc.) are fulfilled with the selection of the appropriate target MEC host, and possible trigger application relocation.

The operations support system 408 is the highest level management system that assists in getting the MEC applications running in the desired location of the network. The operations support system 408 receives request to instantiate and terminate the edge applications from the customer facing service (CFS) portal 410 and applications 411 from user equipment. The CFS portal 410 acts as an entry point for third parties.

The user app LCM proxy 409 is used by MEC application clients to request services related to on-boarding, instantiation and termination of the applications. For example, the user app LCM proxy 409 can be used to request relocation from an external cloud into the MEC system.

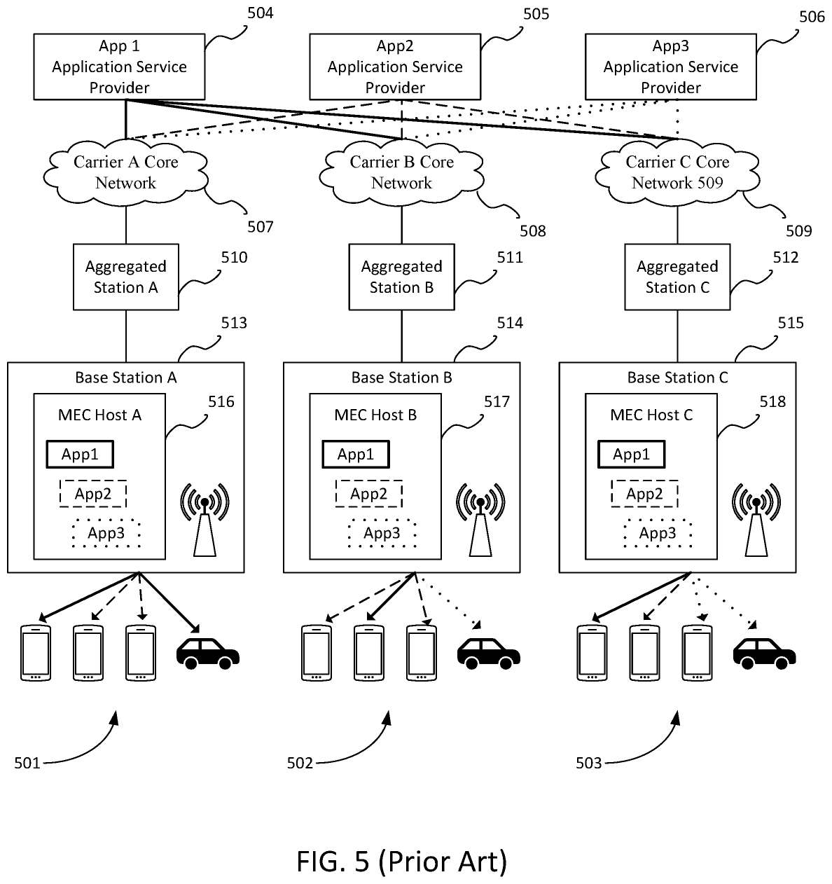

FIG. 5 illustrates MEC hosts deployed on a per carrier basis, wherein each carrier deploys MEC hosts to service user terminals subscribing to the carrier. That is, FIG. 5 illustrates a distributed deployment of application services on a plurality of MEC hosts for a plurality of carriers. Functions of a particular application are typically installed on a plurality of MEC hosts across different carriers, where the functions of a plurality of applications used by user terminals are supported by each MEC host. As illustrated in FIG. 5, which may be for a mobile communication system, a MEC host or server is directly connected to a network at a base station of a carrier. That is, MEC host A 516 is deployed on carrier A's core network 507 and coupled to base station A 513 of carrier A. MEC host B 517 is deployed on carrier B's core network 508 and coupled to base station B 514 of carrier B. MEC host C 518 is deployed on carrier C's core network 509 and coupled to base station C 515 of carrier B. The MEC hosts 516-518 can also be deployed at respective aggregated stations A-C 510-512 in which a plurality of base stations are clustered or at a backbone node (not shown).

According to the illustrated arrangement, an application is deployed in each carrier MEC environment to provide services to many users in the same geographic area in a ubiquitous manner, which may result in inefficiencies. That is, installed on each of the MEC host A-C 516-518 are functions of a plurality of applications (App1, App2, App3), one or more of which are used by the user terminals 501-503. A first plurality of user terminals 501 subscribe to Carrier A, a second plurality of user terminals 502 subscribe to Carrier B, and a third plurality of user terminals 503 subscribe to Carrier C. Each application (App1, App2, App3) is associated with an application service provider (504, 505, 506, respectively). Each application service provider (504, 505, and 506) provides access to its associated application (App1, App2, and App3, respectively) over the carrier networks 507-509. The application service provider and its associated application are deployed on a provider system, typically in the core cloud. For example, applications (App1, App2, App3) are each installed on MEC host A 516, MEC host B 517, and MEC host C 518. MEC host A 516 provides services from the applications (App1, App2, App3) to the first plurality of user terminals 501 subscribing to carrier A. MEC host B 517 provides services from the applications (App1, App2, App3) to the second plurality of user terminals 502 subscribing to carrier B. MEC host C 518 provides services from the applications (App1, App2, App3) to the third plurality of user terminals 503 subscribing to carrier C. Here, base stations A-C 513-515 service the same or similar geographical area. To provide services from any particular application (App1, App2, or App3) to the user terminals 501-503 located in the same geographic area and subscribed to different carriers, the particular application (App1, App2, or App3) is installed on each MEC host 516-518 deployed in each carrier core network 507-509. However, this may result in inefficiencies. For example, consider the scenario where an application on each MEC host is providing the application service to just a few user terminals. In such a scenario, it is inefficient to run the application on each of the MEC hosts since the total amount of network traffic and CPU or memory usage required is small enough to run the application on a single MEC host. When the application sends a large volume of data from the cloud-side of the network to each MEC host, the inefficiency is especially acute when the application is providing services to only a few users.

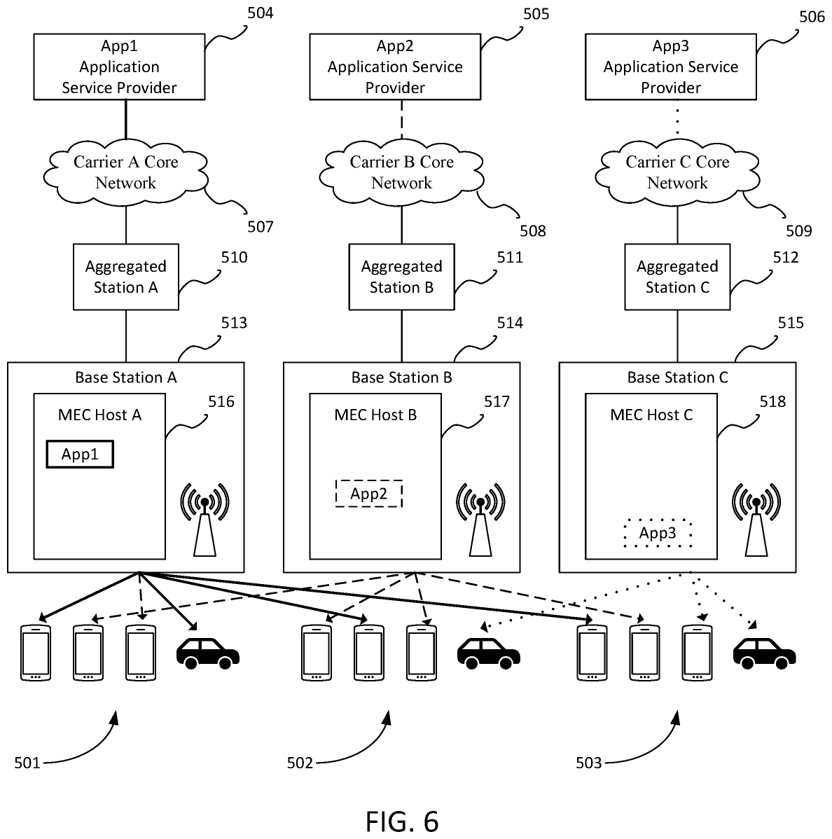

Embodiments of the present invention addresses these inefficiencies by aggregating application functions installed on a plurality of MEC hosts of a plurality of carriers into a single MEC host. Referring now to FIG. 6, with embodiments of the present invention, application functions for App1 for carriers A, B, and C are aggregated into a single MEC host A 516 for a given geographic area. The first, second, and third plurality of user terminals 501-503 subscribing to different carriers A, B, and C connect with MEC host A 516 to receive services from App1. Application functions for App2 can be aggerated into MEC host B 517, and application functions for App3 can be aggregated into MEC host C 518. The first, second, and third plurality of user terminals 501-503 connect with MEC host B 517 to receive services from App2 and connect with MEC host C 518 to receive services from App3.

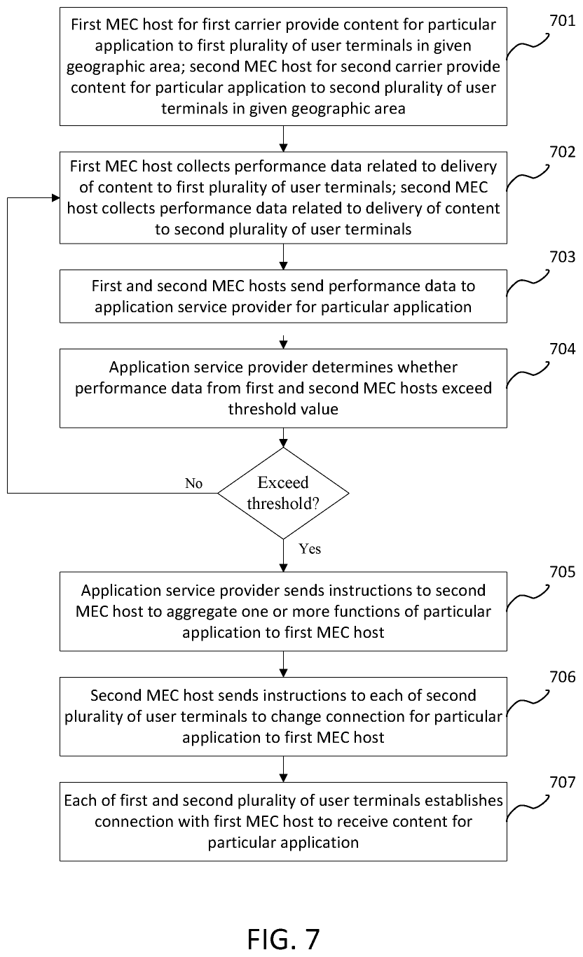

FIG. 7 illustrates a method for aggregating application functions installed on a plurality of MEC hosts of a plurality of carriers in a single MEC host according to an embodiment of the present invention. Referring to both FIGS. 6 and 7, a first MEC host (e.g. MEC host 516) for a first carrier (e.g. carrier A 507) provide content for a particular application (e.g. App1) to a first plurality of user terminals 501 subscribed to carrier A 507 in a given geographic area. A second MEC host (e.g. MEC host 517) for a second carrier (e.g. carrier B 508) provide content for a particular application (App1) to a second plurality of user terminals 502 subscribed to carrier B 508 in the given geographic area (701). The first MEC host 516 collects performance data related to the delivery of content to the first plurality of user terminals 501, and the second MEC host 517 collects performance data related to the delivery of content to the second plurality of user terminals 502 (702). The first and second MEC hosts 516-517 send the performance data to an application service provider (e.g. application service provider 504) for the particular application (App1) (703). In some embodiment, only performance data for the particular application (App1) is collected and sent to the application service provider 504. In other embodiments, depending on the use case, system-wide performance data may be collected, such as an average CPU load and available memory capacity. The application service provider 504 determines whether the performance data from the second MEC host 517 exceeds a threshold value (704). When the performance data exceeds a threshold value, the application service provider 504 sends instructions to the second MEC host 517 to aggregate one or more functions of the particular application (App1) to the first MEC host 516 (705). All the function or part of the functions of the particular application (App1) can be aggregated. In response, the second MEC host 517 sends instructions to each of the second plurality of user terminals 502 to change the connection for the particular application (App1) to the first MEC host 516 (706). As a result, each of the first and second plurality of user terminals 501-502 establishes a connection with the first MEC host 516 to receive content for the particular application (App 1) (707).

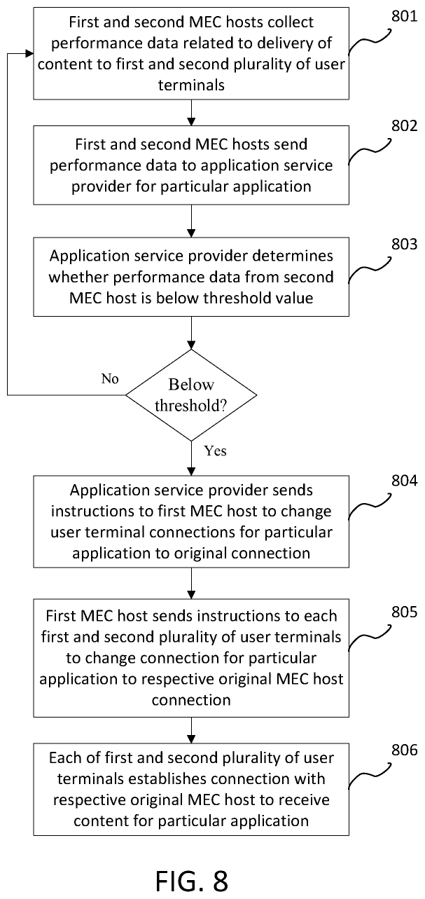

Once aggregated, the performance data at the first and second MEC hosts 516-517 can change such that services for the particular application (App1) can again be efficiently provided in a distributed deployment. FIG. 8 illustrates a method for distributing application functions aggregated on a single MEC host according to an embodiment of the present invention. After the functions of the particular application (App1) is aggregated, as described above, the first and second MEC hosts 516-517 continue to collect performance data related to the delivery of content to the first and second plurality of user terminals 501-502 (801). The first and second MEC hosts 516-517 send the performance data to the application service provider 504 for the particular application (App1) (802). The application service provider 504 determines whether the performance data from the second MEC host 517 is now below the threshold value (803), indicating that the first and second MEC hosts 516-517 may again efficiently provide services for the particular application (App1) in a distributed deployment. When the performance data for the second MEC host 517 is below the threshold value, the application service provider 504 sends instructions to the first MEC host 516, at which the functions of the particular application (App1) is currently aggregated, to change user terminal connections for the particular application to their respective original connections (804). In response, the first MEC host 516 sends instructions to each of the first and second plurality of user terminals 501-502 to change the connections for the particular application (App1) to their respective original MEC host connection (805). In response, each of the first and second plurality of user terminals 501-502 establishes a connection with their respective original MEC host to receive content for the particular application (App1) (806). Thus, each of the second plurality of user terminals 502 change their connections for the particular application (App1) back to the second MEC host 517. The original connections for the first plurality of user terminals 501 are to the first MEC host 516 and thus these connections are not changed.

When three or more MEC hosts serve the same geographic area, aggregation of functions of a particular application occurs in a similar manner. Referring to FIGS. 6 and 7, a third MEC host (e.g. MEC host C 518) also provides content for the particular application (App1) to a third plurality of user terminals 503 in the same given geographic area (701). The third MEC host 518 also collects performance data related to delivery of content to the third plurality of user terminals 503 (702) and sends the performance data to the application service provider 504 for the particular application (App1) (703). The application service provider 504 determines whether the performance data from the second MEC host 517 and/or the third MEC host 518 exceed the threshold value (704), and if so, sends instructions to the second and third MEC hosts 517-518 to aggregate the functions of the particular application (App1) to the first MEC host 516 (705). In response, the second and third MEC hosts 517-518 send instructions to each of the second and third plurality of user terminals 502-503 to change the connection for the particular application (App1) to the first MEC host 516 (706). As a result, each of the first, second, and third plurality of user terminals 501-503 establishes a connection with the first MEC host 516 to receive content for the particular application (App l) (707).

Once aggregated, the performance data at the second MEC host 517 and/or the third MEC host 518 can change such that services for the particular application (App1) can again be efficiently provided in a distributed deployment. Referring to FIG. 8, the second and third MEC hosts 517-518 collect performance data and sends the performance data to the application service provider 504 for the particular application (App1) (801-802). The application service provider 504 determines whether the performance data from the second and/or the third MEC hosts 517-518 is below the threshold value (804). When below the threshold value, the application service provider 504 sends instructions to the first MEC host 516 to change user terminal connections for the particular application to the original connections (804). In response, the first MEC host 516 sends instructions to each of the first, second, and third plurality of user terminals 501-503 to change the connection for the particular application to their respective original MEC host connection (805). In response, the second plurality of user terminals 502 originally connected to the second MEC host 517 each establishes a connection with the second MEC host 517, and the third plurality of user terminals 503 originally connected to the third MEC host 518 each establishes a connection with the third MEC host 518, to receive content for the particular application (App1) (806).

Other applications (e.g. App2 and/or App3) installed on the MEC hosts 516-518 can simultaneously be aggregated on other MEC hosts. For example, App2 can be aggregated onto MEC host B 517, where the MEC host B 517 delivers content from App2 to the user terminals 501-503. App 3 can be aggregated onto MEC host C 518, where the MEC host C 518 delivers content from App3 to the user terminals 501-503. All functions of the application can be aggregated or part of the functions of the application can be aggregated while the remaining functions continue to be serviced in a distributed deployment. In some embodiment, the particular application has several functions, each of which has an entirely different workload. The most overloaded function can be selected as a candidate for aggregation on a single MEC host. For example, in the case of TV program delivering applications, the function of delivering the most popular channel can be aggregated on a single MEC Host, since there are many user terminals simultaneously connected to watch the same contents. In this manner, efficiency is increased by taking functions of the particular application distributed on MEC hosts across multiple carriers and aggregating the functions on a single MEC host that services user terminals across the multiple carriers.

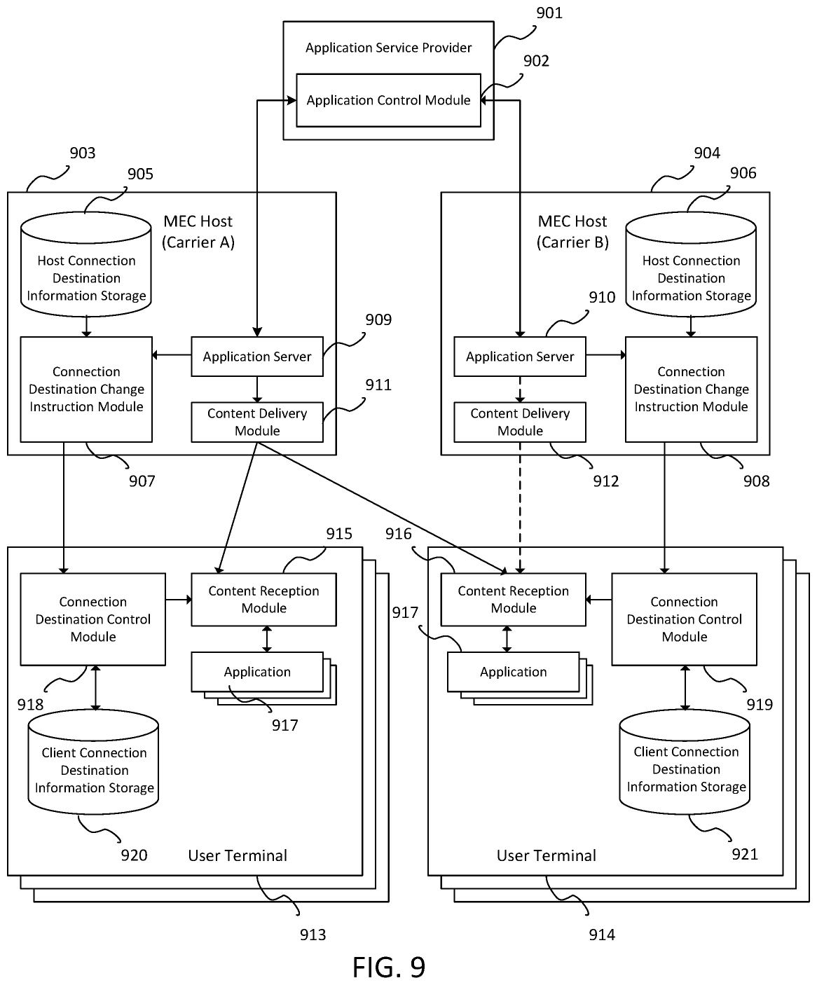

FIG. 9 illustrates in more detail the system of aggregating application functions installed on a plurality of MEC hosts of a plurality of carriers in a single MEC host, according to an embodiment of the present invention. A first MEC host 903 deployed on the network of carrier A includes a first application server 909, which handles operations between a first plurality of user terminals 913 and an application's backend processes. A first content delivery module 911 of the first MEC host 903 delivers content for the applications handled by the first application server 909 to the first plurality of user terminals 913 subscribed to carrier A. One or more of the first plurality of user terminals 913 uses an application 917 associated with the application service provider 901, and a first content reception module 915 of the one or more of the first plurality of user terminals 913 receives content for the application 917 from a first content delivery module 911 of the first MEC host 903.

Similarly, a second MEC host 904 deployed on the network of carrier B includes a second application server 910, which handles operations between a second plurality of user terminals 914 and an application's backend processes. A second content delivery module 912 of the second MEC host 904 delivers content for the applications handled by the second application server 910 to the second plurality of user terminals 914 subscribed to carrier B. One or more of the second plurality of user terminals 914 uses an application 917 associated with the application service provider 901, and a second content reception module 916 of the one or more of the second plurality of user terminals 914 receives content for the application 917 from a second content delivery module 912 of the second MEC host 904.

The first MEC host 903 includes a first host connection destination information storage 905, and the second MEC host 904 includes a second host connection destination information storage 906, for storing information about connection destinations to other carriers, in some embodiments provided from each carrier in advance. Each of the first plurality of user terminals 913 includes a first client connection destination information storage 920, and each of the second plurality of user terminals 914 includes a second client connection information storage 921, for storing information about connection destinations to MEC hosts for each application on the first and second plurality of user terminals 913-914.

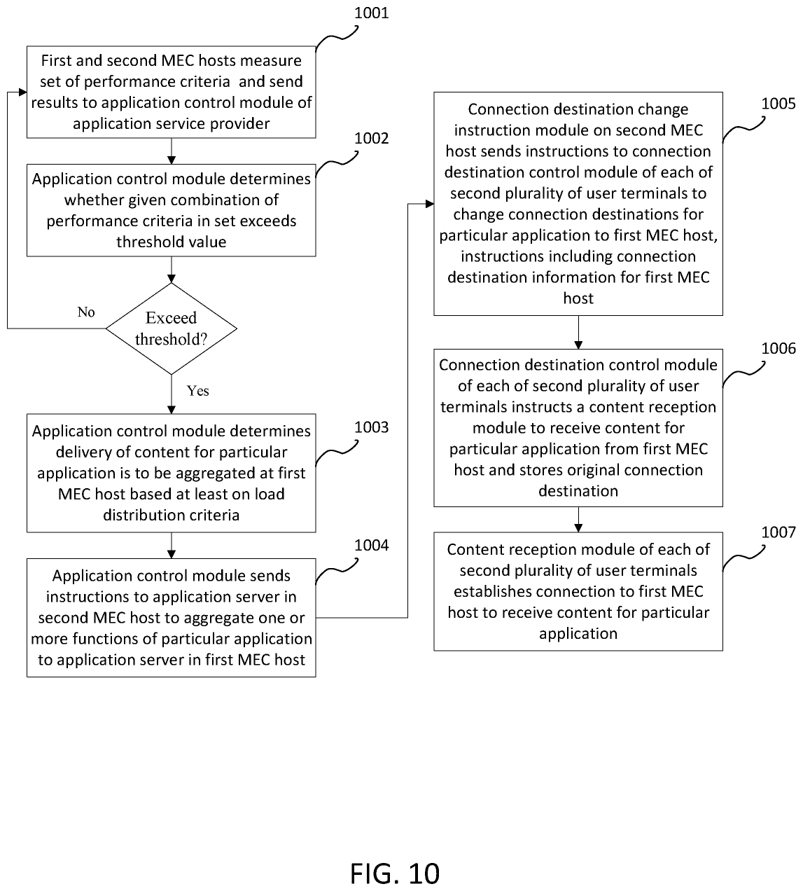

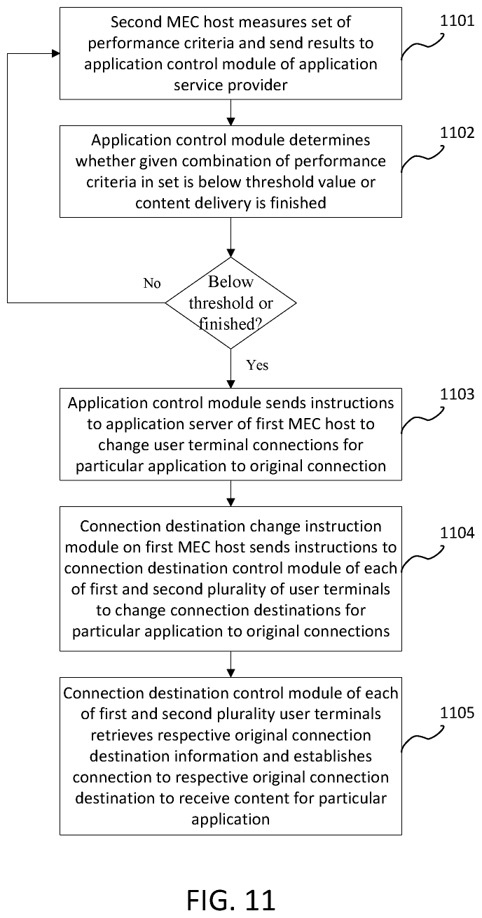

The application service provider 901 includes an application control module 902 for managing the aggregation of functions of its associated application 917. The first MEC host 903 further includes a first connection destination change instruction module 907, and the second MEC host 904 further includes a second connection destination change instruction module 908. Each of the first plurality of user terminals 913 further includes a first connection destination control module 918, and each of the second plurality of user terminals 914 further includes a second connection destination control module 919. The functions of the application control module 902, the host connection destination change instruction modules 907-908, and the connection destination control modules 918-919 are described further below with reference to FIGS. 10 and 11.

Referring to FIGS. 4 and 9, the subcomponents in the first MEC host 903 (i.e., 905, 907, 909, and 911) and the second MEC host 904 (i.e., 906, 908, 910, and 912) are implemented as MEC App 402. These subcomponents are deployed to each MEC host 903, 904 as one of the Virtual Machines (VMs) via Virtualization Infrastructure Manager 406 and Virtualization Infrastructure 404. The application service provider 901 configures and communicates with the application servers 909, 910 through the CFS portal 410. User terminals 913, 914 correspond to the UE App 411 and communicates with the content delivery modules 911, 912 and the connection destination change instruction modules 907, 908 on the MEC host 903, 904 through the User App LCM Proxy 409.

FIG. 10 illustrates in more detail a method for aggregating application functions installed on a plurality of MEC hosts of a plurality of carriers in a single MEC host according to an embodiment of the present invention. Referring to both FIGS. 9 and 10, the application server 909 running on the first MEC host 903 of carrier A provide content of an application 917 associated with the application service provider 901 to the first plurality of user terminals 913. The application server 910 running on the second MEC host 904 of carrier B provide content of the application 917 to the second plurality of user terminals 914. Before aggregation, the first plurality of user terminals 913 connects with the first MEC host 903 to receive content for a particular application 917. The second plurality of user terminals 914 connects with the second MEC host 904 to receive content for the particular application 917. During operation, the first MEC host 903 and the second MEC host 904 each measures a set of performance criteria and sends their respective results to the application control module 902 of the application service provider 901 (1001). The set of performance criteria can include, but not be limited to: a number of user terminals connected to the MEC host; the amount of traffic between the MEC host and the user terminals; system-wide performance data (e.g. average CPU usage and available memory capacity); and user-provided data (e.g. user satisfaction rating). The application control module 902 determines whether a given combination of the performance criteria in the set exceeds a threshold value (1002). For example, the application control module 902 determines whether the number of user terminals connected to the first or second MEC hosts 903-904 exceeds a threshold number, and/or whether the amount of traffic between the first or second MEC hosts 903-904 and their respective connected user terminals 913-914 exceeds a threshold capacity. When the given combination of performance criteria in the set exceeds the threshold value, the application control module 902 determines that the delivery of content for a particular application 917 is to be aggregated at the first MEC host 903, based at least on a load distribution criteria (1003). For example, the number of user terminals connected to the second MEC host 904 exceeds the threshold value, while the first MEC host 903 has capacity for user terminals connected to both the first and second MEC hosts 903-904 without exceeding the threshold value. The determination may also be based on other factors, such as the type of content being delivered by the application 917. For example, assume that a first application (App1) delivers real-time movie content, a second application (App2) delivers still images, and a third application (App3) delivers bidirectional chat or text messages to user terminals. In this case, App1 is the heaviest and most data volume-intensive, and thus aggregating one or more functions of App1 would be the most effective in reducing inefficiencies. By comprehensively evaluating performance data on each MEC host (e.g. average CPU usage, available memory capacity, and number of connecting user terminals), and also considering the aggregation status of other applications on each MEC host, the destination MEC host in which to aggregate functions will be determined. The application control module 902 sends instructions to the application server 910 in the second MEC host 904 to aggregate one or more functions of the particular application 917 to the application server 909 in the first MEC host 903 (1004). Session data and history data are transferred to the first MEC host 903 as needed. By transferring the session data and the history data, some embodiments can also be applied to transaction processing applications that will keep state information. In some embodiments, the size of the session data and the history data are small compared to the size of the content delivered, and hence the impact on the amount of communications among MEC hosts is low.

In response to the instructions from the application control module 902, the connection destination change instruction module 908 on the second MEC host 904 sends instructions to the connection destination control module 919 of each of the second plurality of user terminals 914 to change the connection destinations for the particular application 917 to the first MEC host 903 (1005). The instructions specifies connection destination information for the first MEC host 903. In some embodiments, the change in the connection destination is executed by delivery of instructions to an embedded subscriber identity module (eSIM), a form of programmable SIM card embedded directly into a user terminal. An eSIM enables remote SIM programming of a user terminal. In the instructions to program the eSIM, the connection destination is provided with an identity of the base station to which the first MEC host 903 is connected and the geographic area serviced by the base station. In the case of a dual SIM user terminal, the user terminal may be configured to allow only the particular application 917 to connect to the first MEC host 903 while connections for other applications remain unchanged.

In response to the instructions from the connection destination change instruction module 908, the connection destination control module 919 of each of the second plurality of user terminals 914 instructs a content reception module 916 to receive content for the particular application 917 from the first MEC host 903 and stores the original connection destination in the client connection destination information storage 921 (1006). Here, the original connection destination for each of the second plurality of user terminals 914 is the second MEC host 904. In response to the instructions from the connection destination control module 919, the content reception module 916 of each of the second plurality of user terminals 914 establishes a connection to the first MEC host 903 to receive content for the particular application 917 (1007). The first plurality of user terminals 913 each is already configured to receive content for the particular application 917 from the first MEC host 903, and thus no changes are required. In this manner, delivery of content for the particular application 917 is aggregated on a single MEC host 903. After aggregation, the content delivery module 911 of the first MEC host 903 delivers content for the particular application 917 to the content reception modules 915-916 of each of the first and second plurality of user terminals 913-914.

FIG. 11 illustrates in more detail the method for distributing application functions aggregated on a single MEC host according to an embodiment of the present invention. After the functions of the particular application 917 is aggregated, as described above with reference to FIG. 10, the second MEC host 904 continues to measure the set of performance criteria and to send the results to the application control module 902 of the application service provider 901 (1101). The application control module 902 determines whether a given combination of performance criteria in the set is below the threshold value or whether the content delivery is finished (1102). When the given combination of performance criteria in the set, or when the content delivery is finished, the application control module 902 sends instructions to the application server 909 of the first MEC host 903 to change user terminal connections for the particular application 917 to the original connections (1103). In response, the connection destination change instruction module 907 of the first MEC host 903 sends instructions to the connection destination control module 918-919 of each of the first and second plurality of user terminals 913-914 to change the connection destinations for the particular application 917 to their respective original connections (1104). In response, the connection destination control module 918-919 of each of the first and second plurality of user terminals 913-914 retrieves their respective original connection destination information from their respective client connection destination information storage 920-921 and establishes a connection to their respective original connection destinations for the particular application 917 (1105). For the first plurality of user terminals 913, the original connection for the particular application 917 is the first MEC host 903, and thus the connection destination does not change. For the second plurality of user terminals 914, the original connection for the particular application 917 is the second MEC host 904, and thus the connection destination is changed to the second MEC host 904.

Embodiments for aggregating application functions installed on a plurality of MEC hosts of a plurality of carriers in a single MEC host are described herein. Conventionally, MEC hosts need to be deployed on a per carrier basis to provide services of an application. The services are provided by the MEC hosts in a distributed manner, which can result in inefficiencies. By aggregating one or more functions of the application across carriers on a per application basis according to the embodiments of the present invention, services targeted for a geographic region can be provided more efficiently. This efficiency can be realized in various use scenarios. For example, in a competitive sporting event held within a defined area, such as a stadium, MEC hosts serving as distribution sources for high-resolution video can be aggregated on a per competition event basis according to the embodiments to eliminate duplicate processes and decrease communication load of each MEC host and backbone line. For another example, when the communication service of a certain carrier is disrupted, function(s) of certain types of applications required in an urgent situation (e.g. audio communication service, text communication service, or news delivery service) can be aggregated to a specific MEC host within a geographic area in an MEC environment of another carrier. For another example, the delivery of information concerning transportation accidents, cancellations or delays can be aggregated to an MEC host in order to deliver the information in a more targeted fashion. Vehicles, for example, may be grouped by vehicle type or destinations. For another example, delivery of content of a particular genre or type can be temporarily aggregated to target a certain geographic area.

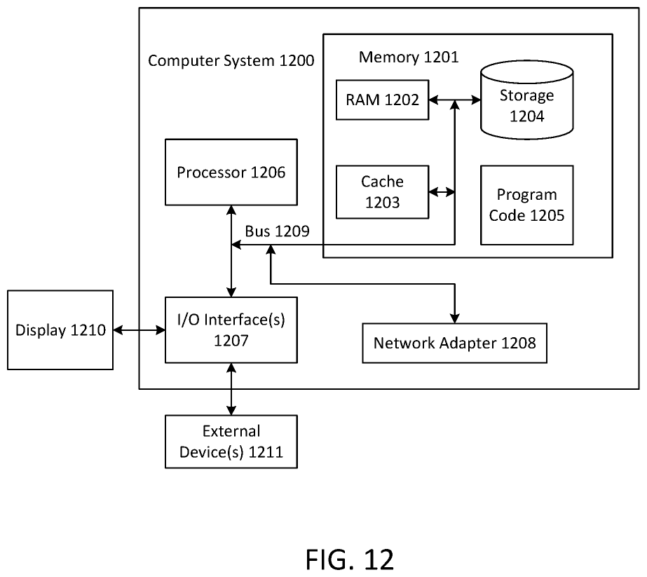

FIG. 12 illustrates a computer system, one or more of which implements the computing components of the network, according to embodiments of the present invention. The computer system 1200 is operationally coupled to a processor or processing units 1206, a memory 1201, and a bus 1209 that couples various system components, including the memory 1201 to the processor 1206. The bus 1209 represents one or more of any of several types of bus structure, including a memory bus or memory controller, a peripheral bus, an accelerated graphics port, and a processor or local bus using any of a variety of bus architectures. The memory 1201 may include computer readable media in the form of volatile memory, such as random access memory (RAM) 1202 or cache memory 1203, or non-volatile storage media 1204. The memory 1201 may include at least one program product having a set of at least one program code module 1205 that are configured to carry out the functions of embodiment of the present invention when executed by the processor 1206. The computer system 1200 may also communicate with one or more external devices 1211, such as a display 1210, via I/O interfaces 1207. The computer system 1200 may communicate with one or more networks via network adapter 1208.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for aggregating application functions on multi-access edge computing (MEC) hosts across multiple carriers, comprising:
receiving performance data from a first MEC host and a second MEC host, by an application service provider system associated with a particular application, the first MEC host deployed on a network of a first carrier and coupled to a first plurality of user terminals, the second MEC host deployed on a network of a second carrier and coupled to a second plurality of user terminals, the particular application being installed on the first MEC host and the second MEC host;
determining, by the application service provider system, whether the performance data from the second MEC host exceeds a threshold value; and
in response to determining that the performance data from the second MEC host exceeds the threshold value, sending, by the application service provider system, instructions to the second MEC host to aggregate one or more functions of the particular application to the first MEC host.

2. The method of claim 1, wherein in response to determining that the performance data from the second MEC host exceeds the threshold value, the application service provider system further:
determines delivery of content for the particular application is to be aggregated at the first MEC host based at least on load distribution criteria; and
sending the instructions to an application server in the second MEC host to aggregate the one or more functions of the particular application to an application server in the first MEC host.

3. The method of claim 1, further comprising:
in response to receiving the instructions from the application service provider system, sending, by the second MEC host, second instructions to each of the second plurality of user terminals to change a connection for the particular application to the first MEC host.

4. The method of claim 3, wherein the sending of the second instructions to each of the second plurality of user terminals comprises:
receiving, by a connection destination change instruction module on the second MEC host, the instructions from the application service provider system; and
in response to receiving the instructions from the application service provider system, sending, by a connection destination change instruction module on the second MEC host, the second instructions to a connection destination control module of each of the second plurality of user terminals to a change connection destination for the particular application to the first MEC host.

5. The method of claim 3, further comprising:
establishing, by each of the first plurality of user terminals and each of the second plurality of user terminals, the connection to the first MEC host to receive content for the particular application.

6. The method of claim 5, wherein in establishing the connection to the first MEC host, each of the second plurality of user terminals:
in response to receiving the second instructions from the second MEC host, instructs, by a connection destination control module, a content reception module to receive content for the particular application from the first MEC host;
stores, by the connection destination control module, an original connection destination for the particular application; and
establishes, by the content reception module, the connection to the first MEC host to receive the content for the particular application.

7. The method of claim 1, wherein after aggregating the one or more functions of the particular application to the first MEC host, the method further comprises:
receiving, by the application service provider system, from the first MEC host and the second MEC host, further performance data related to delivery of content to the first plurality of user terminals and the second plurality of user terminals;
determining, by the application service provider system, whether the further performance data from the second MEC host is below the threshold value; and
in response to determining that the further performance data from the second MEC host is below the threshold value, sending, by the application service provider system, second instructions to the first MEC host to change user terminal connections for the particular application to original connections.

8. The method of claim 7, wherein the determining whether the further performance data from the second MEC host is below the threshold value, comprises:
determining, by the application service provider system, whether a given combination of values in a set of performance criteria received from the second MEC host is below the threshold value or whether content delivery for the particular application is finished.

9. The method of claim 7, further comprising:
in response to receiving the second instructions from the application service provider system, sending, by the first MEC host, second instructions to each of the first plurality of user terminals and each of the second plurality of user terminals to change the connection for the particular application to the original connections.

10. The method of claim 9, wherein the sending of the second instructions to change the connection for the particular application to the original connections comprises:
sending, by a connection destination change instruction module on the first MEC host, third instructions to a connection destination control module of each of the first and second plurality of user terminals to change connection destinations for the particular application to the original connections.

11. The method of claim 9, further comprising:
establishing, by each of the first and second plurality of user terminals, the connection with an original MEC host to receive the content for the particular application.

12. The method of claim 11, wherein the establishing of the connection with the original MEC host comprises:
in response to receiving the third instructions, retrieving, by a connection destination control module of each of the second plurality of user terminals, connection destination information for the second MEC host; and
establishing, by each of the first and second plurality of user terminals, a connection to the second MEC host to receive the content for the particular application.

13. A computer program product for aggregating application functions on multi-access edge computing (MEC) hosts across multiple carriers, the computer program product comprising a computer readable storage medium having program instructions embodied therewith, the program instructions executable by one or more processors to cause the one or more processors to:
receive performance data from a first MEC host and a second MEC host, by an application service provider system associated with a particular application, the first MEC host deployed on a network of a first carrier and coupled to a first plurality of user terminals, the second MEC host deployed on a network of a second carrier and coupled to a second plurality of user terminals, the particular application being installed on the first MEC host and the second MEC host;
determine, by the application service provider system, whether the performance data from the second MEC host exceeds a threshold value; and
in response to determining that the performance data from the second MEC host exceeds the threshold value, send, by the application service provider system, instructions to the second MEC host to aggregate one or more functions of the particular application to the first MEC host.

14. The computer program product of claim 13, wherein the one or more processors are further caused to:
in response to receiving the instructions from the application service provider system, sending, by the second MEC host, second instructions to each of the second plurality of user terminals to change a connection for the particular application to the first MEC host.

15. The computer program product of claim 13, wherein after aggregating the one or more functions of the particular application to the first MEC host, the one or more processors are further caused to:
receive, by the application service provider system, from the first MEC host and the second MEC host, further performance data related to delivery of content to the first plurality of user terminals and the second plurality of user terminals;
determine, by the application service provider system, whether the further performance data from the second MEC host is below the threshold value; and
in response to determining that the further performance data from the second MEC host is below the threshold value, send, by the application service provider, second instructions to the first MEC host to change user terminal connections for the particular application to original connections.

16. The computer program product of claim 15, wherein the one or more processors are further caused to:
in response to receiving the second instructions from the application service provider system, send, by the first MEC host, third instructions to each of the first plurality of user terminals and each of the second plurality of user terminals to change the connection for the particular application to the original connections.

17. A system, comprising:
a first MEC host deployed on a network of a first carrier and coupled to a first plurality of user terminals;
a second MEC host deployed on a network of a second carrier and coupled to a second plurality of user terminals;
an application service provider system coupled to the network of the first carrier and to the network of the second carrier, wherein a particular application associated with the application service provider system is installed on the first MEC host and the second MEC host, wherein the application service provider system:
receives performance data from the first MEC host and the second MEC host,
determines whether the performance data from the second MEC host exceeds a threshold value, and
in response to determining that the performance data from the second MEC host exceeds the threshold value, sends first instructions to the second MEC host to aggregate one or more functions of the particular application to the first MEC host,
wherein in response to receiving the first instructions, the second MEC host sends second instructions to each of the second plurality of user terminals to change a connection for the particular application to the first MEC host.

18. The system of claim 17, wherein after aggregating the one or more functions of the particular application to the first MEC host,
the application service provider system:
receives further performance data related to delivery of content to the first plurality of user terminals and the second plurality of user terminals from the first MEC host and the second MEC host
determines whether the further performance data from the second MEC host is below the threshold value; and
in response to determining that the further performance data from the second MEC host is below the threshold value, sends third instructions to the first MEC host to change user terminal connections for the particular application to original connections,
wherein in response to receiving the third instructions, the first MEC host sends fourth instructions to each of the first plurality of user terminals and each of the second plurality of user terminals to change the connection for the particular application to the original connections.

19. A method for aggregating application functions on multi-access edge computing (MEC) hosts across multiple carriers, comprising:
receiving values for a set of performance criteria from a first MEC host and a second MEC host, by an application service provider system associated with a particular application, the first MEC host deployed on a network of a first carrier and coupled to a first plurality of user terminals, the second MEC host deployed on a network of a second carrier and coupled to a second plurality of user terminals, the particular application being installed on the first MEC host and the second MEC host;
determining, by the application service provider system, whether a given combination of the performance criteria in the set from the second MEC host exceeds a threshold value;
in response to determining that the given combination of the performance criteria in the set from the second MEC host exceeds the threshold value, determining, by the application service provider system, that delivery of content for the particular application is to be aggregated at the first MEC host based at least on load distribution criteria;
sending, by the application service provider system, instructions to an application server in the second MEC host to aggregate the one or more functions of the particular application to an application server in the first MEC host.

20. The method of claim 19, further comprising:
receiving, by a connection destination change instruction module on the second MEC host, the instructions from the application service provider system; and
in response to receiving the instructions from the application service provider system, sending, by a connection destination change instruction module on the second MEC host, second instructions to a connection destination control module of each of the second plurality of user terminals to change connection destinations for the particular application to the first MEC host.

21. The method of claim 20, further comprising:
receiving, by the connection destination control module of each of the second plurality of user terminals, the second instructions to change the connection destinations for the particular application to the first MEC host; and
in response to receiving the second instructions, instructing a content reception module of each of the second plurality of user terminals to receive content for the particular application from the first MEC host and storing the original connection destination.

22. A method for distributing aggregated functions of an application across multi-access edge computing (MEC) hosts across multiple carriers, comprising:
aggregating one or more functions of a particular application to a first MEC host, the first MEC host deployed on a network of a first carrier and coupled to a first plurality of user terminals subscribed to the first carrier, the first MEC host further coupled to a second plurality of user terminals subscribed to a second carrier, the second plurality of user terminals further coupled to a second MEC host deployed on a network of the second carrier;
after aggregating the one or more functions of the particular application to the first MEC host, receiving, by an application service provider system associated with the particular application, from the first MEC host and the second MEC host, values of a set of performance criteria related to delivery of content to the first plurality of user terminals and the second plurality of user terminals;
determining, by the application service provider system, whether a given combination of values in the set of performance criteria received from the second MEC host is below the threshold value or whether content delivery for the particular application is finished; and
in response to determining that the given combination of values in the set of performance criteria from the second MEC host is below the threshold value or determining that the content delivery for the particular application is finished, sending, by the application service provider system, instructions to an application server of the first MEC host to change user terminal connections for the particular application to original connections.

23. The method of claim 22, further comprising:
in response to the instructions, sending, by a connection destination change instruction module on the first MEC host, second instructions to a connection destination control module of each of the first and second plurality of user terminals to change connection destinations for the particular application to the original connections.

24. The method of claim 23, further comprising:
in response to the second instructions, retrieving, by the connection destination control module of each of the second plurality of user terminals, connection destination information for the second MEC host; and
establishing, by each of the second plurality of user terminals, the connection to the second MEC host to receive the content for the particular application.
